(19) United States
(12) Patent Application Publication
(10) Pub. No.: US 2009/0095393 A1
(43) Pub. Date: Apr. 16, 2009

(54) TIRE CHAIN ASSEMBLY AND METHOD OF INSTALLATION

(75) Inventors: Daniel L. Davis, Sedalia, MO (US); John D. Beecroft, Concordia, MO (US)

Correspondence Address: HOVEY WILLIAMS LLP, 10801 Mastin Blvd., Suite 1000, Overland Park, KS, 66210, US

(73) Assignee: Polar Quick Trax, L.L.C., Concordia, MO (US)

(21) Appl. No.: 12/252,126

(22) Filed: Oct. 15, 2008

Related U.S. Application Data
(60) Provisional application No. 60/979,977, filed on Oct. 15, 2007.

(51) Int. Cl. B60C 27/06

(52) U.S. Cl. 152/242

(57) ABSTRACT

A tire chain assembly is provided that includes a disk that is mounted between dual wheels on a vehicle. A tire chain having a number of cross chains is then releaseably attached to the disk and across the tread surface of the tire using disk connectors that are attached to the end of the cross chains and are interconnected in key slots in the disk. The tire chain can be removed by simply disconnecting the disk connectors from the disk. The tire chain can be installed and removed while the vehicle is stationary.

### CROSS-REFERENCE TO RELATED APPLICATION

Priority benefits under 35 U.S.C. §119(e) are claimed in this application from provisional application Ser. No. 60/979,977, filed on Oct. 15, 2007, the entirety of the disclosure of which is hereby specifically incorporated herein by this reference thereto.

### BACKGROUND OF THE INVENTION

The present invention relates generally to tire chains, also known as snow chains and, more particularly, to a tire chain assembly for use with dual-wheeled vehicles and a method of installing same.

Tire chains are applied to the drive wheels of a vehicle to provide greater traction on roads covered with snow or ice. Most tire chains comprise two circular outer chains, one on each side of the tire, connected by a plurality of evenly spaced cross chains that extend across the tire tread.

The tire chains are normally installed by laying the chains on the ground in front or behind of the vehicle's drive wheels and then driving the vehicle onto the chains. The chains are then wrapped around the tires and the side chains are fastened together by a suitable connector. Some types of chains for large commercial vehicles also include a plurality of cam-like tensioners in the side chains which are used to tighten the side chains and thereby cause the cross chains to tightly grip the tire tread.

Conventional tire chains suffer from a number of disadvantages. If the side chain connectors and/or tensioners are not properly tightened or if they loosen as the vehicle is driven, the chains may become detached from the wheel or the wheel may spin within the chain and cause the vehicle to lose traction. Installation of the tire chains is also time-consuming because the installer must first exit the vehicle to position the chains on the ground, then reenter the vehicle and drive it onto the chains, and then exit the vehicle again to complete the installation by wrapping the chains around the wheels, attaching the side chain connectors, and maneuvering the tensioners to tighten the side chains. In situations where a vehicle is stuck in snow, it can be difficult or impossible to apply these types of conventional tire chains because the vehicle cannot be driven onto the chains. Installation of the tire chains also normally requires that the installer lay on the ground, which is normally covered in snow or slush, to reach the back side of the wheel to fasten the inner side chain connector and maneuver the tensioners. Because the tire chains must often be applied while the vehicle is parked on the shoulder of the road, the vehicle and the installer are exposed to other traffic traveling along the road. Removal of these types of tire chains is also time-consuming because the individual must first disconnect the chains, return to the vehicle to drive it off of the chains, and then leave the vehicle to pick up the chains from the ground.

These installation and removal difficulties and hazards are further magnified when the vehicle is a commercial vehicle that has double or dual drive wheels, each of which may need to be chained. Such vehicles may frequently encounter primary roads which have been cleared of snow or ice and secondary roads which are remain covered in snow or ice. Similarly, vehicles traveling through mountainous areas may frequently encounter stretches of road covered in snow or ice and other stretches of road that are dry. Because the tires and chains can be subject to excessive wear when the vehicle is driven on dry roads, the driver may need to frequently stop to remove or reapply the tire chains as different road conditions are encountered. Because of these difficulties and hazards in installing and removing conventional tire chains, many drivers of commercial vehicles prefer to simply park the vehicle and wait for better road conditions or, worse, drive their vehicles without installing the tire chains.

A need has thus developed for tire chains that can be used with vehicles having dual wheels and which overcome the above-described disadvantages of conventional tire chains.

### SUMMARY OF THE INVENTION

In one aspect, the present invention is directed to a tire chain assembly for use on a vehicle having dual wheels which mount tires having tread surfaces. The tire chain assembly includes a generally planar circular disk. The disk includes a first series of concentrically arrayed holes through which a set of wheel lugs may extend to permit mounting of the disk between an inner and an outer wheel in the pair of dual wheels. The disk further includes a second series of holes arrayed about an outer periphery of said disk. In one embodiment, the second series of holes each comprises a key slot having an enlarged portion and a narrower portion that extends radially outward from said enlarged portion. The tire chain assembly further includes a tire chain which has an outer ring element, a number of cross chains each connected at one end to the outer ring element, and a disk connector at an opposite end of each of said cross chains for interconnecting with one of the second series of holes to releaseably attach the cross chain to said disk. When the disk connectors are attached to the disk, the cross chains extend across the tread surfaces of the tires. A tensioner is positioned in the outer ring element to tighten the cross chains against the tread surfaces of said tires when the disk connectors are interconnected with the second series of holes in said disk. In one embodiment, the outer ring element is a length of chain.

The disk connectors each have a body portion, a pin protruding from the body portion and having a neck portion and an enlarged head positioned at an end of the neck portion, and a locking element carried by the body portion. The neck portion of said pin is sized to move along the narrower portion of the key slot and the enlarged head is sized to insert through the enlarged portion of the key slot and not pass through the narrower portion of the key slot to prevent detachment of the pin from the key slot when the neck portion is positioned in the narrower portion of the key slot. The locking element is moveable between a locked position preventing removal of the pin from said key slot and a released position allowing removal of the pin from the key slot.

In another aspect, the present invention is directed to a method of installing a tire chain to a generally planar circular disk mounted between the inner and outer wheels in a pair of dual wheels. The method comprises the steps of attaching a series of cross chains to the disk by releaseably attaching a disk connector at one end of each of the cross chains to the disk. The cross chains are connected at an opposite end to an outer ring element, such as a chain. After attachment of the disk connectors to the disk, the cross chains extend across the tread surface of the tires at spaced apart intervals.

### BRIEF DESCRIPTION OF THE SEVERAL VIEWS OF THE DRAWINGS

In the accompanying drawings which form part of the specification and are to be read in conjunction therewith and in which like reference numerals are used to indicate like parts in the various views:

FIG. 1 is a rear perspective view of a vehicle having dual wheels on which is mounted a tire chain assembly constructed in accordance with the present invention;

FIG. 2 is an enlarged fragmentary, side perspective view showing the tire chain mounted to an outer wheel in one pair of dual wheels;

FIG. 3 is a fragmentary rear perspective view of one pair of the dual wheels;

FIG. 4 is a exploded fragmentary perspective view showing the components of the tire chain assembly and the dual wheels;

FIG. 5 is a perspective view of the tire chain assembly installed on one of the dual wheels, with portions removed to better illustrate the tire chain assembly;

FIG. 6 is a fragmentary perspective view showing a disk connector on one of the cross chains of the tire chain assembly interconnected with the disk and a locking element positioned in a locked position;

FIG. 7 is a fragmentary perspective view similar to that shown in FIG. 6, but showing the locking element in a released position;

FIG. 8 is a side elevation view of the components shown in FIG. 5;

FIG. 9 is an enlarged fragmentary perspective view showing one face of the disk connector;

FIG. 10 is an enlarged fragmentary perspective view similar to FIG. 9, but showing an opposite face of the disk connector;

FIG. 11 is an enlarged perspective view similar to that shown in FIG. 9, but showing the locking element in a released position;

FIG. 12 is a fragmentary front perspective view taken in vertical section along line 12-12 in FIG. 8 and showing the disk connector interconnected with the disk;

FIG. 13 is a fragmentary front perspective view similar to that shown in FIG. 12, but showing the locking element in a released position;

FIG. 14 is a fragmentary front perspective view similar to that shown in FIG. 13, but showing the disk connector in the process of being detached from the disk; and

FIG. 15 is a fragmentary perspective view showing tire chains attached to both wheels in a pair of dual wheels.

### DETAILED DESCRIPTION OF THE INVENTION

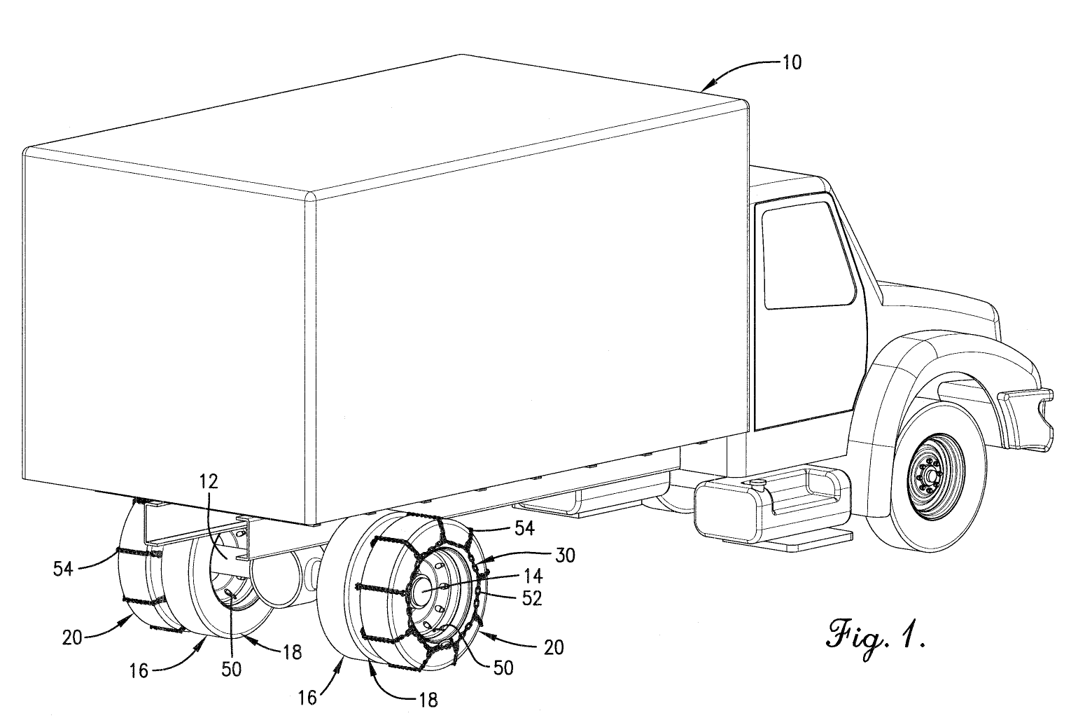

Turning now to the drawings in greater detail and initially to FIG. 1, a vehicle is represented broadly by the numeral 10 and comprises a drive axle 12 that mounts dual wheel hubs 14 at opposite ends of the drive axle 12. Each hub 14 in turn mounts a pair of dual wheels 16 that comprise an inner wheel 18 and an outer wheel 20. The wheels 18 and 20 are secured together by a series of lug bolts 22 that extend from the hub 14 through aligned holes in the wheels 18 and 20. Lug nuts 24 are threaded on the lug bolts 22 and are tightened against the outer wheel 18. Each wheel 18 and 20 mounts a tire 26 having an outer tread surface 28.

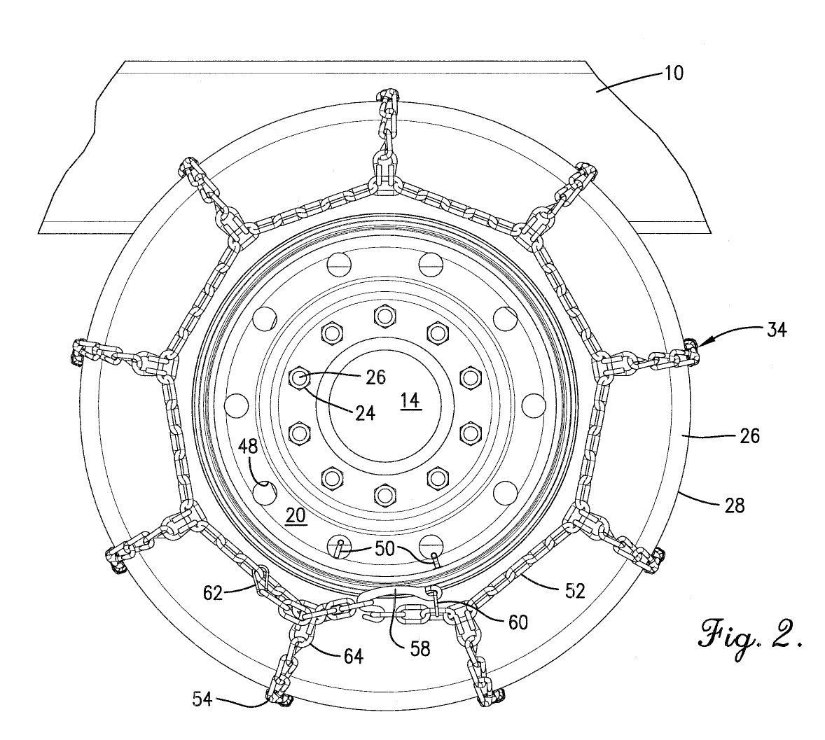

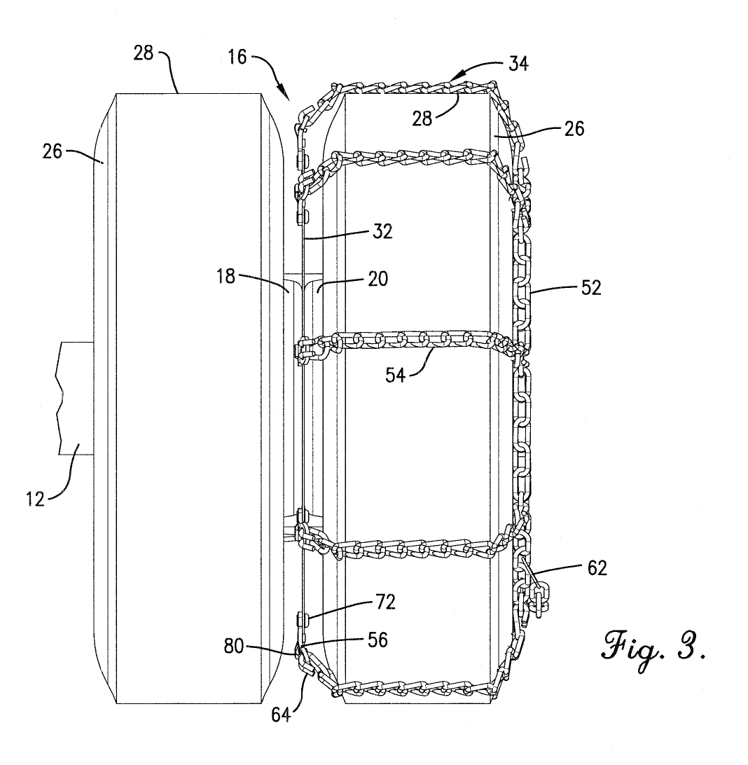

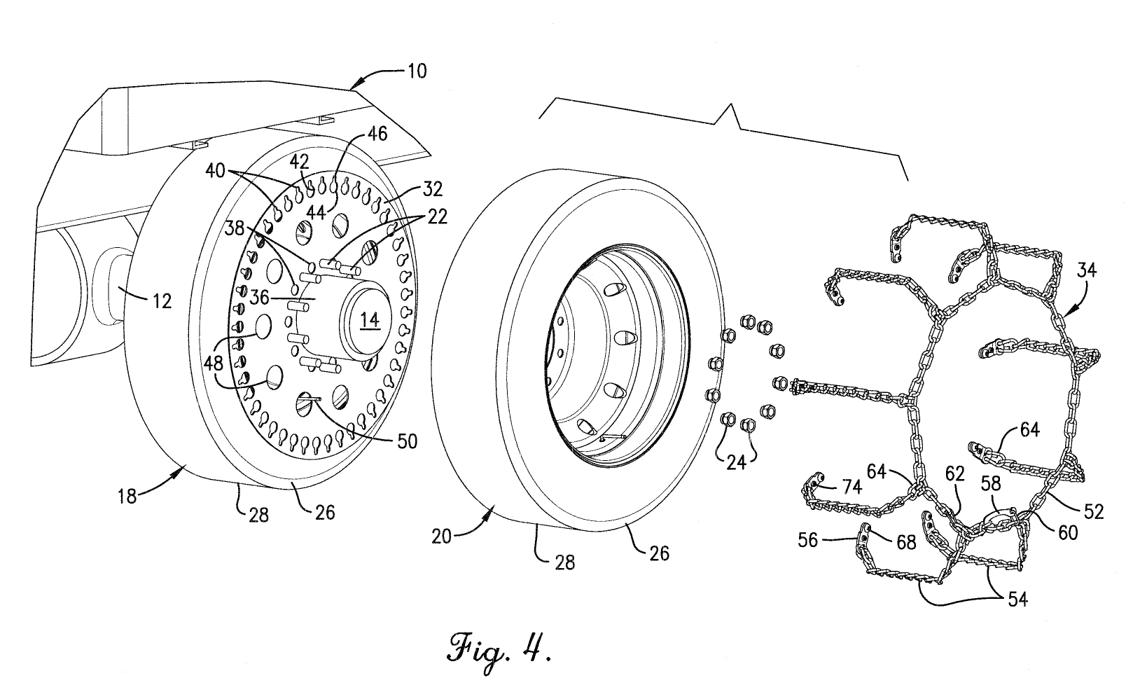

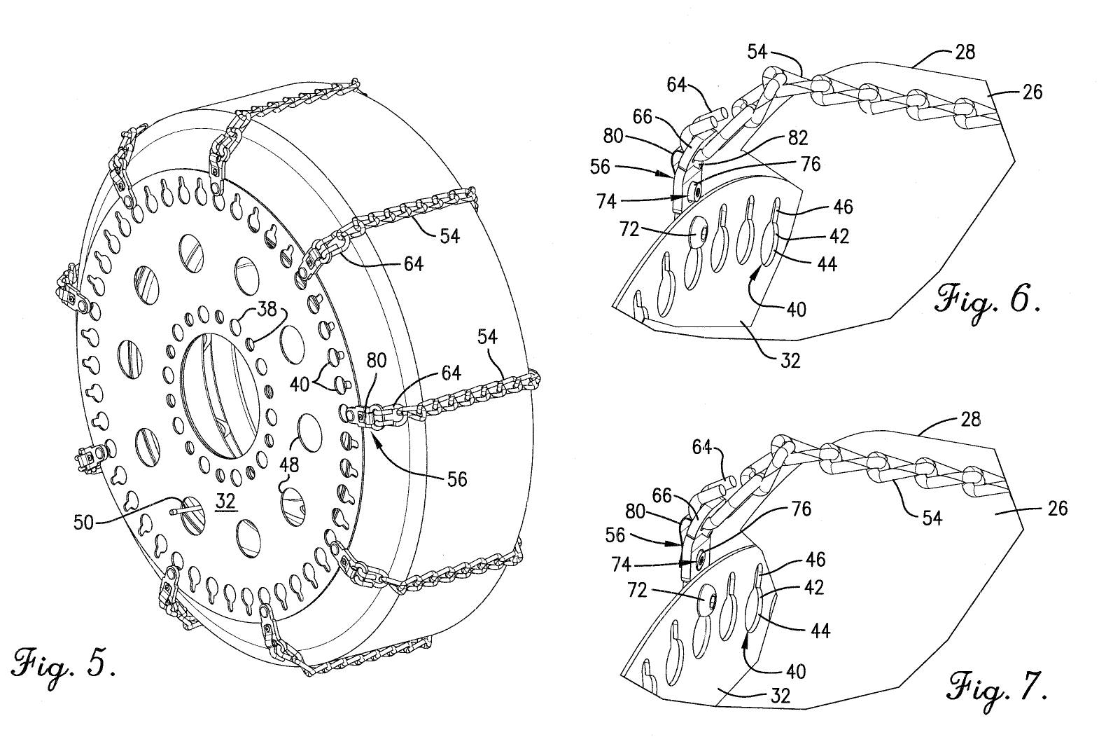

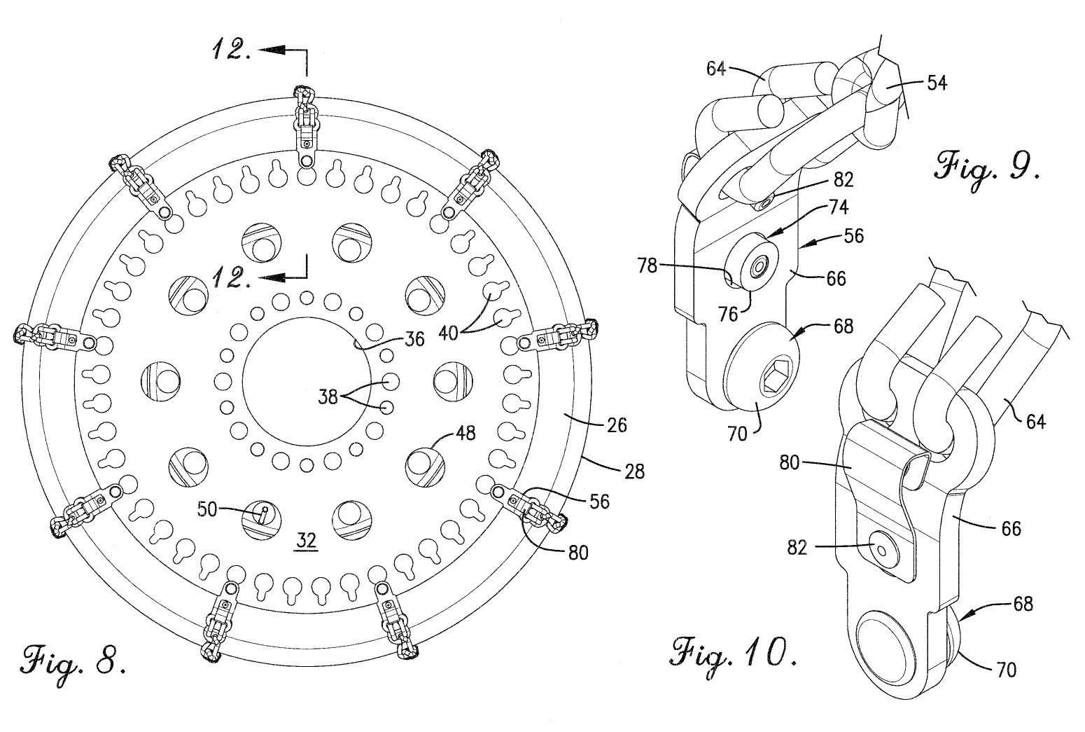

Turning additionally to FIGS. 2-15, in accordance with the present invention, a tire chain assembly 30 is provided and comprises a generally planar, circular disk 32 that is mounted between the inner and outer wheels 18 and 20 and a tire chain 34 that releaseably interconnects with the disk 32.

Each disk 32 has a center opening 36 sized for mounting on the wheel hub 14 and a first series of holes 38 sized and concentrically arrayed for allowing the lug bolts 22 to be inserted through the holes 38. In order to accommodate different patterns of lug bolts 22, more holes 38 may be provided than are actually used with some of the holes 38 arranged for one pattern of lug bolts 22 and other holes 38 arranged for another patent of lug bolts 22. A second series of holes 40 is positioned near an outer periphery of the disk 32 for attachment of the chain assembly 30 in a manner to be subsequently described. In the illustrated embodiment, the holes 40 are each fashioned as a key slot 42 having an enlarged portion 44 and a narrower portion 46 that extends radially outward from the enlarged portion 44. The number of holes 40 used in the disk 32 can vary from the number illustrated in the drawings.

Each disk 32 also includes a third series of concentrically arrayed holes 48 that allow the valve stem 50 from the tire 26 on the inner wheel 18 to extend through the disk 32 for more convenient access. A plurality of the holes 48 are normally used to ensure that the disk 32 can be mounted so that the valve stem 50 is aligned with at least one of the holes 48. It is to be understood, however, that the number of holes 48 can be varied from that illustrated in the drawings and, in some instances, a single hole 48 may be used.

The disks 32 are formed from a suitably rigid material, including steel and other metals and their alloys. The steel or other metal may be treated to reduce corrosion, including by applying a coating to the metal by powder coating, electroplating, or other techniques.

The disk 32 is initially mounted with the dual wheels 16 by removing the lug bolts 22 and the outer wheel 20, inserting the disk 32 onto the lug bolts 22, and then reinstalling the outer wheel 20 so that the disk 32 is tightly sandwiched between the inner and outer wheels 18 and 20. The disk 32 can then remain permanently mounted or it can be removed at the end of each winter season.

The tire chain 34 that releaseably attaches to the disk 32 comprises an outer ring element 52 and a plurality of cross chains 54 that are connected at one end to the outer ring element 52 and at an opposite end to a disk connector 56. The outer ring element 52 is normally a length of chain, but it could be in other forms such as a metal cable or a series of interconnected metal cables.

The outer ring element 52 includes a tensioner 58 that interconnects opposite ends of the outer ring element 52 and can be maneuvered to tighten the outer ring element 52. In the illustrated embodiment, the tensioner 58 is a lever arm that is connected to an end link at one end of the chain and is inserted through a link at or near the opposite end of the chain. The lever arm is then pivoted to draw the end links closer together and is secured in place by an extra link 60 carried on the chain. Any resulting loose links at the end of the chain are secured to the tensioned chain by a carabiner 62 or other connection device.

One end of each cross chain 54 is secured to the outer ring element 52 by a suitable coupler 64 and the opposite end of each cross chain 54 is connected to the disk connector 56 by another coupler 64. The couplers 64 are preferably link-type couplers that allow relative movement between the cross chain 54 and the couplers 64.

The number of cross chains 54 is normally selected based on local regulations governing the use of tire chains and/or local road conditions. In one embodiment, five cross chains 54 are used for each drive wheel. In another embodiment, nine cross chains 54 are used for each drive wheel. More or fewer cross chains 54 can be used in other embodiments. It is to be understood that the number of cross chains 54 need not be the same for each drive wheel. For example, the tire chains 32 on the inner wheels 18 may have a fewer number of cross chains 54 than the tire chains 32 on the outer wheels 20. As but one example, five cross chains 54 may be used for the inner wheels 18 and nine cross chains may be used for the outer wheels 20. The cross chains 54 are normally uniformly spaced apart.

The cross chains 54 are normally formed from twisted links that allow better contact between the cross chains 54 and the tread surface 28 of the tire. Alternatively, other types of links may be used. The cross chains 54 are preferably formed of case hardened metal, but other types of suitably strong and durable materials may be used.

Turning more specifically to FIGS. 9-14, the disk connector 56 comprises a flat body element 66 having a pin 68 secured to one end of the body element 66 opposite from the coupler 64. The pin 68 has a neck 70 that extends outwardly from a face of body element 66 and terminates in an enlarged head 72. In one embodiment, the pin 68 can be a bolt inserted into a threaded hole in the body element 66 and welded in place. The neck 70 and head 72 of the pin 68 are cooperatively sized in relation to the key slot 42 so that the head 72 may be inserted through the enlarged portion 44 of the key slot 42 in the disk 32 and the neck 70 is then able to slide along the narrower portion 46 of the key slot 42 in a radially outward direction along the disk 32 as tension is applied to the associated cross chain 54. The head 72 of the pin 68 is sized large enough that it is unable to pass through the narrower portion 46 of the key slot 42, thereby securing the interconnection between the disk connector 56 and the disk 32 when tension is applied to the cross chain 54.

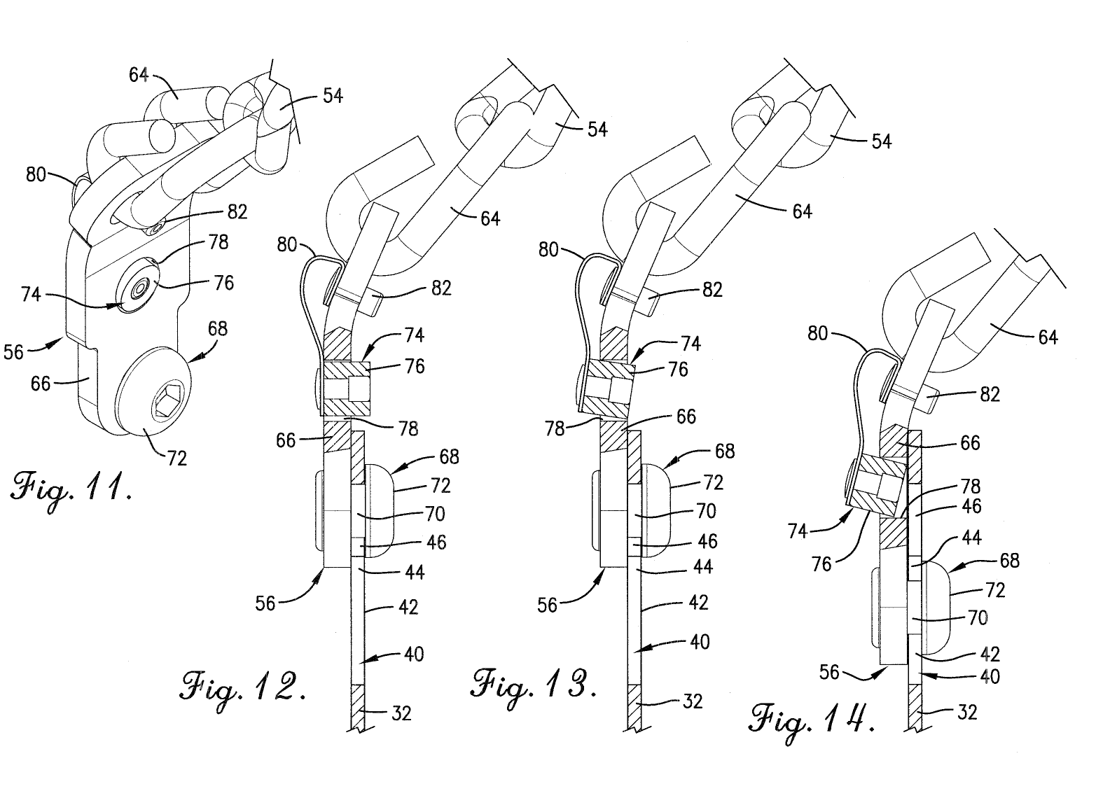

To prevent inadvertent detachment of the disk connector 56 from the disk 32, a locking element 74 is carried by the disk connector 56. The locking element 74 comprises a cylindrical or other shaped lug 76 that extends through a hole 78 in the body element 66. The lug 76 is spaced from the pin 68 by a distance slightly greater than the distance from the radially outer end of the key slot 42 to the peripheral edge of the disk 32. The lug 76 is biased by a leaf spring 80 toward a locking position with the lug 76 extending beyond the surface of the body element 66. The leaf spring is secured to the body element 66 by a rivet 82 or other fastener. The lug 76 can be manually depressed into the hole 78 and moved toward a released position in which the lug 76 is recessed within the 78, as shown in FIGS. 7 and 13. As a result, when the pin 68 is inserted into the key slot 42, the face of the disk 32 bears against the lug 76 and causes it to become recessed within the hole 78. When tension is applied to the associated cross chain 54, the pin 68 slides to the end of the key slot 42 and the lug 76 is no longer in contact with the face of the disk 32. The spring 80 moves the lug 76 to its locking position, shown in FIGS. 6 and 12, where it extends beyond the surface of the body element 66 and engages the edge of the disk 32 to prevent removal of the disk connector 56 from the disk 32. The lug 76 can then be manually depressed to permit disconnection of the disk connector 56 from the disk 32.

A slight bend may be formed in the body element 66 of the disk connector 56 to facilitate positioning of the disk connector 56 between the tires 26 during the process of attaching the disk connector 56 to the disk 32 or removing it therefrom. The disk connector 56 is formed from steel or other metals or metal alloys and may be coated, such as by cadmium or zinc electroplating, to resist corrosion.

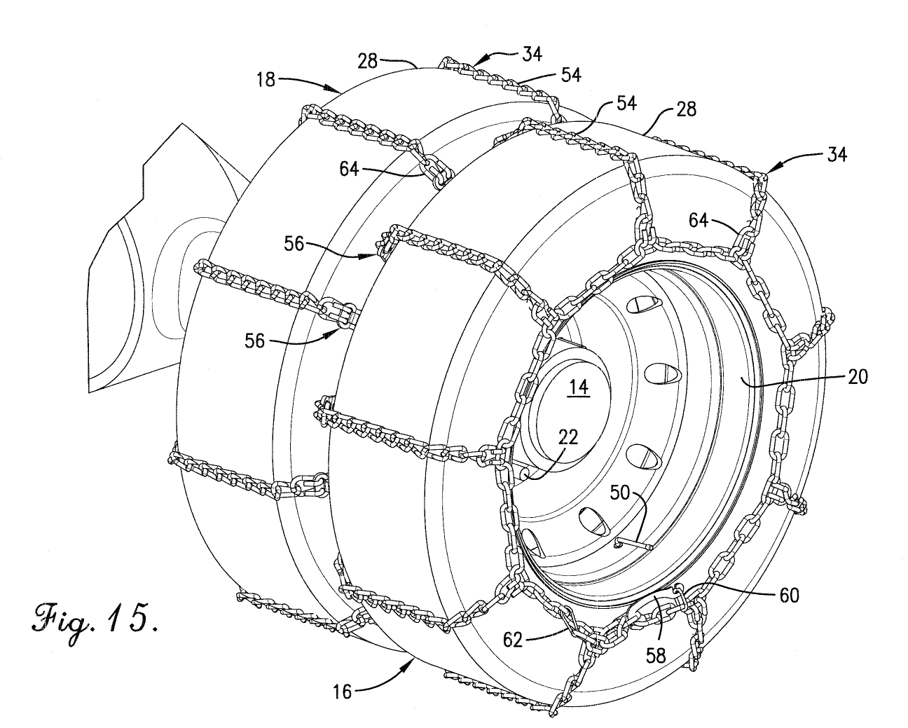

One of the tire chains 32 is mounted to either the inner wheel 18 or the outer wheel 20 in each pair of dual wheels 16, as shown in FIGS. 1-4. Another tire chain 34 can then be mounted to the other wheel 18 or 20 in each pair of dual wheels 16, as shown in FIG. 15.

During installation of the tire chain 34 on one of the wheels 18 or 20, the centrally positioned cross chain 54 is normally attached on the back side of the disk 32 by inserting the pin 68 on the associated disk connector 56 into the key slot 42 at generally the 12 o'clock position on the disk 32. The disk connector 56 is then moved in a radially outward direction along the surface of the disk 32 until the locking element 74 snaps into place as a result of the biasing action of the leaf spring 80. The outer ring element 52 is then positioned on the side of the wheel 18 or 20 opposite from the disk 32. The remaining cross chains 54 are then sequentially attached to the disk 32 in a similar manner at equally spaced intervals about the periphery of the disk 32. The order of attachment of the cross chains 54 can be varied depending on the preferences of the installer. Once all of the cross chains 54 have been attached, the tensioner 58 which is generally located at the 6 o'clock position is then maneuvered to place the outer ring element 52 in tension, thereby causing the cross chains 54 to tighten across the tread surface 28 of the tire 26. The tensioner 58 is then locked in place by the extra link 60 and the loose links at the end of the chain are secured to the tensioned chain by the carabiner 62.

If tire chains 34 are to be installed on both wheels 18 and 20 in the pair of dual wheels 16, as shown in FIG. 15, the installation procedure described above is generally repeated except the disk connectors 54 of the respective tire chains 34 are positioned on opposite sides of the same disk 32 and are rotationally offset from each other.

Removal of the tire chains 34 can be readily accomplished by simply releasing the tensioner 58 to create slack in the cross chains 54 and then removing the disk connectors 54 from the disk 32 by depressing the locking elements 74 and moving the disk connectors 54 in a radially inward direction to release the pin 68 from the associated key slot 42, as illustrated in FIGS. 12-14. In some instances, the vehicle 10 may need to be moved slightly if one of the cross chains 54 is underneath the tire 26.

Because the disk 32 is driven with the dual wheels 16, it can be seen that attachment of the tire chains 34 to the disk 32 prevents the wheels 16 from slipping within the tire chains 34, a problem which can occur with conventional tire chains. The tire chains 34 can be installed or removed while the vehicle 10 is stationary, thus the tire chains 34 can be applied even when the vehicle has already become stuck in the snow. Importantly, the tire chains 34 can be quickly and easily installed and removed, thereby increasing the likelihood that a driver will actually use the tire chains 34 rather than simply parking the vehicle 10 or driving in an unsafe manner without the tire chains 34.

From the foregoing, it will be seen that this invention is one well adapted to attain all the ends and objectives hereinabove set forth together with other advantages which are inherent to the structure.

It will be understood that certain features and subcombinations are of utility and may be employed without reference to other features and subcombinations. This is contemplated by and within the scope of the invention.

Since many possible embodiments may be made of the invention without departing from the scope thereof, it is to be understood that all matter herein set forth or shown in the accompanying drawings is to be interpreted as illustrative and not in a limiting sense.

Having thus described the invention, what is claimed is:

1. A tire chain assembly for use on a vehicle having dual wheels mounted on an axle hub, said assembly comprising:
a generally planar circular disk;
a center opening sized for receiving the axle hub;
a first series of concentrically arrayed holes in said disk through which a set of wheel lugs may extend to permit mounting of the disk between an inner and an outer wheel in a pair of dual wheels which mount tires having tread surfaces;
a second series of holes arrayed about an outer periphery of said disk; and
a tire chain comprising an outer ring element and a number of cross chains, each of said cross chains being connected at one end to the outer ring element and at an opposite end to a disk connector that interconnects with one of said second series of holes to releaseably attach the cross chain to said disk, wherein the cross chains extend across the tread surfaces of the tires when said disk connectors are interconnected with said second series of holes in said disk.

2. The tire chain assembly of claim 1, wherein said outer ring element is a chain.

3. The tire chain assembly of claim 2, wherein said holes in said second series of holes each comprises a key slot having an enlarged portion and a narrower portion that extends radially outward from said enlarged portion.

4. The tire chain assembly of claim 3, wherein each of said disk connectors comprises a body portion and a pin protruding from said body portion, said pin having a neck portion and an enlarged head positioned at an end of said neck portion.

5. The tire chain assembly of claim 4, wherein said neck portion of said pin is sized to move along said narrower portion of the key slot and said enlarged head is sized to insert through said enlarged portion of the key slot and not pass through said narrower portion of the key slot to prevent detachment of said pin from said key slot when the neck portion is positioned in said narrower portion of the key slot.

6. The tire chain assembly of claim 5, including a locking element carried by said body portion of the disk connector and moveable between a locked position preventing removal of said pin from said key slot and a released position allowing removal of said pin from said key slot.

7. The tire chain assembly of claim 6, wherein said locking element is spring-biased toward said locked position.

8. The tire assembly of claim 1, including a tensioner positioned in said outer ring element to tighten the cross chains against the tread surfaces of said tires when the disk connectors are interconnected with said second series of holes in said disk.

9. The tire chain assembly of claim 1, wherein said cross chains comprise twist links.

10. The tire chain assembly of claim 1, wherein the number of cross chains is nine.

11. The tire chain assembly of claim 1, wherein the number of cross chains is five.

12. A method of installing a tire chain to dual wheels on a vehicle, said dual wheels comprising an inner wheel and an outer wheel connected together by a set of lugs and nuts and mounting tires having tread surfaces, said dual wheels having a generally planar circular disk mounted between the inner and outer wheels, said method comprising the steps of:
attaching a series of cross chains to said disk by releaseably attaching a disk connector at one end of each of said cross chains to said disk, said cross chains being connected at an opposite end to an outer ring element, whereby said cross chains extend across the tread surface of said tires at spaced apart intervals.

13. The method of claim 12, including the step of tensioning the outer ring element to tighten the cross chains against said tread surface of said tires.

14. The method of claim 13, wherein said outer ring element is a chain and said step of tensioning the outer ring element comprises inserting a tensioning lever through a link in the chain and maneuvering the tensioning lever to apply tension to said chain.

15. The method of claim 14, wherein said step of attaching a series of cross chains to said disks comprises inserting a portion of said disk connectors into a hole at an outer periphery of said disk to releaseably secure said disk connector within said hole.

16. A tire chain assembly for use on a vehicle having dual wheels, said assembly comprising:
a generally planar circular disk;
a first series of concentrically arrayed holes in said disk through which a set of wheel lugs may extend to permit mounting of the disk between an inner and an outer wheel in a dual wheel which mounts tires having tread surfaces;
a second series of holes arrayed about an outer periphery of said disk and comprising a key slot having an enlarged portion and a narrower portion that extends radially outward from said enlarged portion; and
a tire chain comprising: an outer ring element, a number of cross chains each connected at one end to the outer ring element, a disk connector at an opposite end of each of said cross chains for interconnecting with one of said second series of holes to releaseably attach the cross chain to said disk, wherein the cross chains extend across the tread surfaces of the tires when said disk connectors are interconnected with said second series of holes in said disk, and a tensioner positioned in said outer ring element to tighten the cross chains against the tread surfaces of said tires when the disk connectors are interconnected with said second series of holes in said disk,
wherein each of said disk connectors comprises a body portion, a pin protruding from said body portion and having a neck portion and an enlarged head positioned at an end of said neck portion, and a locking element carried by said body portion of the disk connector,
wherein said neck portion of said pin is sized to move along said narrower portion of the key slot and said enlarged head is sized to insert through said enlarged portion of the key slot and not pass through said narrower portion of the key slot to prevent detachment of said pin from said key slot when the neck portion is positioned in said narrower portion of the key slot, and
wherein said locking element is moveable between a locked position preventing removal of said pin from said key slot and a released position allowing removal of said pin from said key slot.

17. The tire chain assembly of claim 16, wherein said outer ring element is a chain.

18. The tire chain assembly of claim 17, wherein said locking element is spring-biased toward said locked position.
